(19) United States
(12) Patent Application Publication
(10) Pub. No.: US 2025/0058616 A1
(43) Pub. Date: Feb. 20, 2025

(54) CHASSIS OF A VEHICLE

(71) Applicant: Robert Bosch GmbH, Stuttgart (DE)

(72) Inventors: Erik Goerres, Abstatt (DE); Heiko Kaiser, Schwieberdingen (DE)

(21) Appl. No.: 18/726,004

(22) PCT Filed: Dec. 23, 2022
(86) PCT No.: PCT/EP2022/087772

§ 371 Date: Jul. 1, 2024

(30) Foreign Application Priority Data
Jan. 12, 2022 (DE) 10 2022 200 232.6

(51) Int. Cl. B60K 1/04; B60K 1/00; H01M 10/613; H01M 10/625; H01M 10/6567; H01M 50/204; H01M 50/249

(52) U.S. Cl. CPC B60K 1/04; H01M 10/613; H01M 10/625; H01M 10/6567; H01M 50/204; H01M 50/249; B60K 2001/005; B60K 2001/0405; H01M 2220/20

(57) ABSTRACT

The present invention relates to a chassis (1) of a vehicle (10), comprising: a battery arrangement (2), a front axle (3), and a rear axle (4), wherein the battery arrangement (2) is arranged in an intermediate space (20) between the two axles (3, 4) and additionally partially outside the intermediate space (20) in the chassis longitudinal direction (15), and wherein the battery arrangement (2) is designed as a co-supporting element of the chassis (1).

### BACKGROUND

The present invention relates to a vehicle chassis and a vehicle.

Chassis usually form the load-bearing element of a vehicle, such as a passenger car. In the region of passenger cars, self-supporting bodies are also known as load-bearing elements of the vehicle. The chassis has the function of carrying a drive, one or more engines, add-on parts and a payload of the vehicle. If the vehicle is an electric vehicle, a battery is usually provided as an electrical energy store that supplies the motor or motors with electrical energy. The battery is often designed as a flat box and is bolted or otherwise connected to the chassis from below.

### SUMMARY

In contrast, the chassis according to disclosure is characterized in that a particularly lightweight construction can be provided. In addition, optimum utilization of the installation space for the largest possible battery can be made possible, whereby the highest possible battery capacities and thus ranges can be achieved depending on the available installation space. According to the invention, this is achieved by a chassis comprising a battery arrangement, a front axle and a rear axle. The front axle and rear axle are preferably arranged to be connected to wheels of the vehicle. The battery arrangement is arranged in an intermediate space between the two axles, as well as additionally partially outside the intermediate space in the chassis longitudinal direction. In addition, the battery arrangement is designed as a co-supporting element of the chassis. The battery arrangement is preferably set up to provide electrical energy to a drive system of the vehicle, for example to an electric motor, which is provided in particular as a drive motor for moving the vehicle.

In other words, a chassis is provided in which the battery arrangement is provided as a co-supporting element, for example in order to support payloads and/or components and/or add-on parts of the vehicle. The battery arrangement is also designed such that it is located between the two axles, as well as additionally within a front and/or rear carriage, in particular wherein the front carriage and rear carriage are each adjacent to the intermediate space between the two axles in the chassis longitudinal direction, and wherein the respective axle is located within the front carriage or rear carriage. Preferably, at least a partial region of the battery arrangement thus extends from the intermediate region beyond at least one of the two axles. This makes it possible to ensure that as much of the chassis space as possible is available for the battery arrangement. In particular, the battery can be extended into previously unused regions of the vehicle. As a result, chassis with battery arrangements with the largest possible volume can be provided, which allows high battery capacities. The mechanical integration of the battery arrangement as a co-supporting element of the chassis also offers the advantage that a particularly lightweight design of the chassis can be made possible, since, for example, a proportion of frame or carrier elements or the like, which only contribute to the mechanical stability of the chassis, can be significantly reduced. This means that partial regions or elements of the chassis that only fulfill a load-bearing function can be reduced, enabling a particularly simple, lightweight and cost-effective design of the chassis.

Preferably, the battery arrangement has several battery cells and a battery housing. In particular, the battery cells are arranged within the battery housing. Preferably, the battery cells are intended for storing electrical energy. The battery housing forms the co-supporting element of the chassis. In addition to protecting the battery cells from environmental influences and mechanical loads, the battery housing can therefore also be used as a co-supporting element of the chassis. This means that mechanical forces are at least partially absorbed by the battery housing during operation or when the chassis is in use.

The battery arrangement is preferably designed as a one-piece battery module. This means that the battery arrangement forms a defined component designed as a single mechanically integrated unit. This enables a particularly low chassis weight and optimum space utilization, for example for the battery cells.

Preferably, the battery arrangement is made up of several parts and comprises at least two interconnected battery modules. Preferably, the battery modules are at least electrically and mechanically connected to each other. The mechanical connection is preferably designed such that an outer shell, in particular a common outer shell, of the interconnected battery modules closes the connection interface to the outside, in particular protecting it from environmental influences. It is particularly preferred that additional lines for a coolant for a cooling circuit are provided in the region where the battery modules are connected. Preferably, only one of the battery modules forms a co-supporting element of the chassis. This allows a modular design of the battery arrangement to be provided. This means that, depending on the intended use of the chassis, only one of the battery modules can be used. In another application, the battery arrangement can be extended by one or more additional battery modules in order to provide a higher battery capacity. This makes it particularly easy and cost-effective to provide a chassis that can be flexibly adapted to different applications.

The battery arrangement particularly preferably has a first battery module and at least one second battery module. The first battery module is arranged in the intermediate space between the front axle and the rear axle. The second battery module extends from the first battery module beyond the respective axle, i.e. beyond the front axle or the rear axle. Preferably, several second battery modules can be provided, for example a total of two second battery modules, wherein one of the second battery modules extends over the front axle or over the rear axle. This makes it particularly easy and cost-effective to provide a modular structure for the chassis. For example, one of the second battery modules can be replaced by a second electric motor or other components.

Two battery modules are also preferably connected to each other by means of a connection interface. The connection interface establishes a mechanical and electrical connection between the two battery modules. Alternatively or additionally preferred, the connection interface establishes a mechanical and coolant connection. Preferably, the connection interface is formed in a contact surface of the two connected battery modules. This allows a particularly compact, material-saving and well-protected connection interface to be provided.

Preferably, the chassis also comprises a receiving chamber which is set up to accommodate components of the vehicle, such as a motor and/or a steering device. The receiving chamber is at least partially enclosed by the battery arrangement. This enables optimum positioning of the receiving chamber, which, for example, allows weight savings due to the possibility of reducing the length of shafts or carriers or the like. In addition, the components that can be arranged in the receiving chamber can be protected by the battery arrangement that at least partially surrounds them.

It is particularly preferred that the receiving chamber is completely enclosed by the battery arrangement in at least one plane. Preferably, the plane is parallel to each of the two axles. This means that in a circumferential direction lying in the plane, the receiving chamber is completely surrounded by the battery arrangement. For example, the receiving chamber can be designed as a recess that completely penetrates the battery arrangement in a direction perpendicular to the plane.

Preferably, the chassis also comprises a cooling system. The cooling system has a common cooling circuit for the battery arrangement and for at least one component housed in the receiving chamber. This makes it possible to achieve a particularly simple and efficient design of the chassis, which allows efficient cooling of the battery arrangement and the additional component(s). A cooling device for cooling the component is particularly advantageously designed as part of a cooling device of the battery arrangement, i.e. integrated into the cooling system of the battery arrangement. In addition, a particularly efficient cooling system can be provided, since, for example, a flow path that a coolant has to cover to cool the battery module and/or component can be reduced, for example to provide a low pressure loss.

Preferably, the chassis further comprises an electric motor which is arranged, in particular at least partially, in the receiving chamber. By integrating the electric motor into the receiving chamber within the battery arrangement, a particularly advantageous design of the chassis can be achieved in terms of light weight and low costs. For example, drive shafts can be routed from the electric motor to the wheels of the vehicle at optimum angles and in short lengths, for example compared to mounting the electric motor outside the battery arrangement. In addition, advantageous electrical integration can be provided, as fewer and/or shorter electrical cables are required, for example. The electric motor is particularly preferably integrated into the common cooling circuit of the battery arrangement. Preferably, cooling of the electric motor is designed as jacket cooling, wherein a cooling liquid flows through the stator housing. For example, part of the battery arrangement can form a housing around the stator and form a channel wall for the coolant flow.

Preferably, the chassis also comprises power electronics that are integrated into the battery arrangement. In particular, the power electronics are arranged within the battery housing. This can further increase the overall integration of the chassis. In addition, electrical integration in particular can be optimized by using few, short cables that are also mechanically protected and protected from environmental influences. It is particularly preferable for the power electronics to be integrated into the common cooling circuit of the battery arrangement. This enables particularly simple and efficient cooling of the chassis components.

Electrical cables are particularly preferably arranged within the battery arrangement, preferably exclusively. The electrical cables are set up for the electrical connection of the battery arrangement and the electric motor. Alternatively or additionally, the electrical cables are preferably arranged for the electrical connection of the battery arrangement and the power electronics. The electrical lines can preferably be rigid lines, for example made of copper, or printed conductors. The fact that the electrical lines are arranged within the battery arrangement, which is preferably designed as a single, in particular rigid, component, makes it possible to dispense with flexibility and/or complex insulation of the lines, which means that a particularly simple, cost-effective and lightweight design can be provided.

Preferably, the chassis also comprises several connecting elements on the battery arrangement, which are set up for connection to a body and/or to chassis components and/or to add-on parts. For example, the connecting elements can be integral, i.e. preferably in one piece, with the battery housing and form attachment points for other elements of a vehicle. In this way, a particularly advantageous mechanical integration of the battery arrangement into the vehicle chassis can be achieved.

Preferably, the chassis also comprises at least one or more of the following components: Drive train, chassis components, steering, wheels. For example, several of the aforementioned components can be provided so that the chassis forms a ready-to-run or self-propelled chassis, in particular a so-called “rolling chassis”.

The invention also relates to a vehicle comprising the chassis described. Preferably, the vehicle is an electric vehicle. Further preferably, the vehicle is a passenger car.

### BRIEF DESCRIPTION OF THE DRAWINGS

Exemplary embodiments of the invention are described in detail hereinafter with reference to the accompanying drawings. In the drawings:

FIG. 1 a simplified schematic view of a vehicle comprising a chassis according to a first exemplary embodiments of the invention,

FIG. 2 is a simplified schematic view of the chassis of FIG. 1,

FIG. 3 an alternative detailed view of the chassis of FIG. 1,

FIG. 4 a further alternative view of the chassis of FIG. 1, and

FIG. 5 a simplified schematic view of a chassis according to a second exemplary embodiment of the invention.

### DETAILED DESCRIPTION

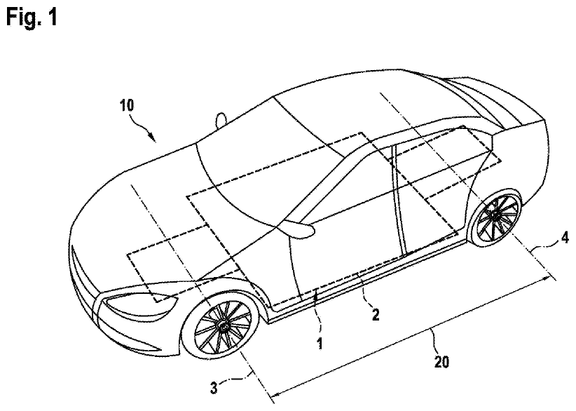

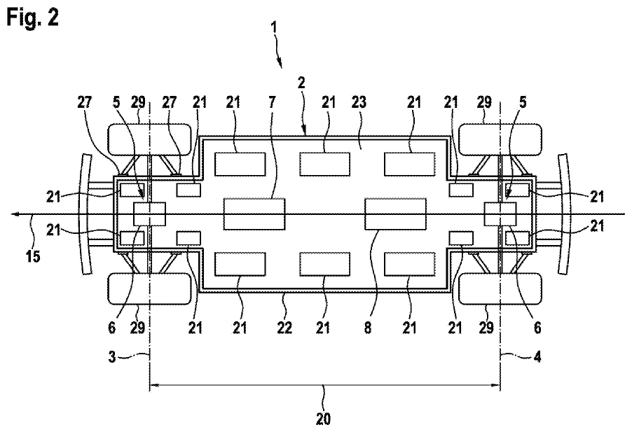

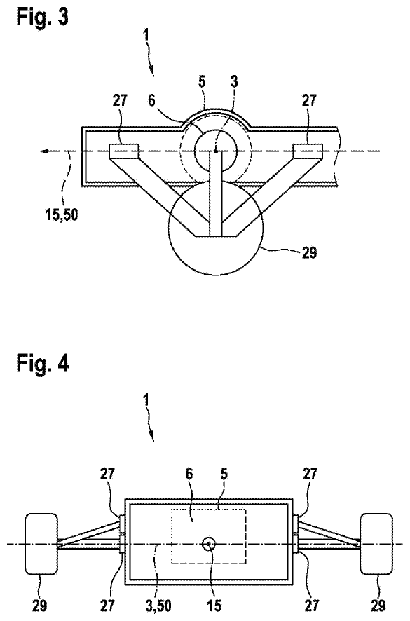

FIG. 1 shows a simplified schematic perspective view of a vehicle 10 with a chassis 1 according to a first exemplary embodiment of the invention. Chassis 1 is also shown in more detail in FIG. 2. Further detailed views of the chassis 1 of the first exemplary embodiment are shown in FIGS. 3 and 4.

The vehicle 10 is a passenger car that is designed as an electric car. The vehicle 10 can therefore be driven exclusively by an electric drive.

The drive of the vehicle 10 is integrated into the chassis 1. In detail, the chassis 1 comprises two electric motors 6 (see FIG. 2), which are provided as drive motors for the vehicle 10. One of the two electric motors 6 is arranged on a front axle 3 and one on a rear axle 4 of the chassis 1. Each motor 6 drives the wheels 29 of the respective axle 3, 4.

To power supply to the electric motors 6, the chassis 1 comprises a battery arrangement 2. The battery arrangement 2 has several battery cells 21 and a battery housing 22.

Preferably, the battery arrangement 2 is located on an underbody of the vehicle 10. Particularly preferably, an underside of the battery housing 22 forms at least part of the underbody of the vehicle 10.

The battery cells 21 are designed to store electrical energy. The electric motors 6 are thus supplied with power by means of the battery cells 21. Additionally, electrical energy generated by the electric motors 6 can preferably be stored, for example in the form of recuperation.

The battery arrangement 2 is designed as a co-supporting element of the chassis 1. This means that the battery arrangement 2 is an integral part of the load-bearing structure of the vehicle 10. This load-bearing structure is intended in particular to support vehicle components and payloads.

In detail, the battery housing 22, which can be designed as a sintered component or as a cast component, for example, is designed as a co-supporting element of the chassis 1. This allows for an advantageous functional integration of the battery housing 22, namely on the one hand a protective and retaining function of the battery cells 21, and on the other hand a contribution to the mechanical stability and load-bearing function of the chassis 1.

The fact that the battery housing 22 fulfills at least part of the load-bearing function of the chassis 1 means that the number and/or volume of other load-bearing elements, such as struts or frames, can be reduced or omitted altogether. Thus, the chassis 1 offers the further advantage of a particularly low weight.

At the same time, optimum space utilization is made possible by the integrity of the battery arrangement 2. This means that the largest possible proportion of the space available in the vehicle 10 can be used for battery cells 21 in order to be able to provide batteries with a high capacity even in small vehicles with a small wheelbase, for example, and thus enable the vehicles 10 to have a long range.

The optimum utilization of installation space is achieved particularly advantageously by the specific arrangement and design of the battery arrangement 2, as described below.

The battery arrangement 2, i.e. battery housing 22 and battery cells 21, are arranged within an intermediate space 20 between the two axles 3, 4 and also extend beyond each of the two axles 3, 4 in the chassis longitudinal direction 15. This means that partial regions of the battery arrangement 2 are also arranged outside the intermediate space 20 defined between the two axles 3, 4. As a result, additional installation space in the front carriage and in the rear carriage can be utilized for further battery cells 21, for example between the wheels 29. The entire battery arrangement 2 is designed as a single one-piece battery module 23.

It is also advantageous for optimum utilization of installation space and a low overall weight of the chassis 1 if components of the vehicle 10 are attached directly to the battery arrangement 10. This is achieved by the battery arrangement 2 having several connecting elements 27 on the battery housing 22. The connecting elements 27 are designed for connection to a body, to chassis components and to add-on parts of the vehicle 10. In particular, as can be seen in FIG. 2, handlebars of a tire suspension and similar chassis components are attached to the battery arrangement 2 by means of the connecting elements 27. This means that frame elements can be dispensed with and short and lightweight handlebars can be used for wheel suspension.

Furthermore, the chassis 2 comprises a receiving chamber 5 for each electric motor 6, in which the respective electric motor 6 is housed. The receiving chamber 5 is shown schematically in simplified form in FIGS. 2 to 4. No battery cells 21 are arranged within the receiving chamber 5. The receiving chamber 5 is integrated into the battery arrangement 2 in such a way that it completely surrounds the receiving chamber 5 in a plane 50. The plane 50 is a virtual plane in which the two axles 3, 4 lie. In particular, an output shaft of the respective electric motor 6 is located in plane 50, i.e. within the battery arrangement 2.

By integrating the electric motors 6 into the battery arrangement 2, an advantageous design of the power transmission path to the wheels 29 can be achieved. In detail, this means that short drive shafts arranged at a shallow angle can be used, as can be seen in FIGS. 3 and 4, for example. In particular, this allows a low weight and a cost reduction of the chassis 1 to be achieved.

Furthermore, the chassis 1 comprises power electronics 8, which are provided in particular for controlling the provision of energy from the battery cells 21 to the electric motors 6. The power electronics 8 are integrated into the battery arrangement 2, namely arranged within the battery housing 22. As a result, electrical cables (not shown) can be arranged essentially entirely within the battery housing 22. As a result, electrical cables that are easy and inexpensive to manufacture, such as rigid copper cables, can be used, which do not have to be flexible and do not have to be elaborately protected and insulated against environmental influences. The electrical energy transmission path can therefore be designed to be particularly simple, cost-effective and lightweight.

The chassis 1 also comprises a cooling system 7, which is set up to cool the battery cells 21, the electric motors 6 and the power electronics 8 by means of a common cooling circuit (not shown). This allows a particularly high level of system integration to be achieved. Furthermore, flow paths of the cooling system 7 can be optimally designed, for example to achieve short flow paths and low flow resistances.

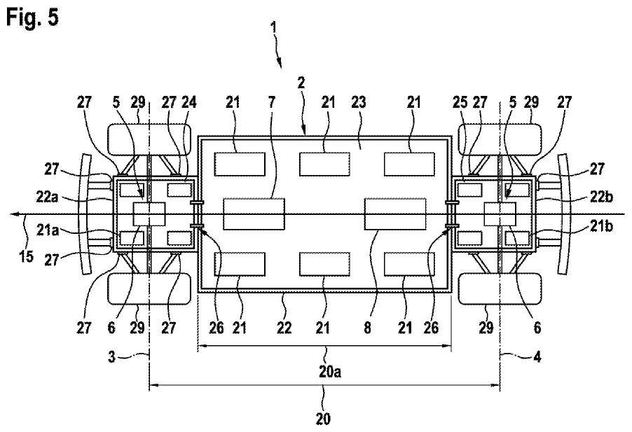

FIG. 5 shows a simplified schematic view of a chassis 1 according to a second exemplary embodiment of the invention. The second exemplary embodiment essentially corresponds to the first exemplary embodiment of FIGS. 1 to 4, with the difference that the battery arrangement 2 is made up of several parts. In the second exemplary embodiment, the battery arrangement 2 comprises several battery modules 23, 24, 25, which are interconnected.

A first battery module 23 is arranged in the intermediate space 20. In detail, the first battery module 23 is arranged within a partial intermediate space 20a, which is located in the chassis longitudinal direction 15 between the wheels 29 or wheel housings in which the wheels 29 are arranged.

Furthermore, in the second exemplary embodiment, the battery arrangement 2 comprises two second battery modules 24, 25. The two second battery modules 24, 25 are each arranged directly adjacent to the first battery module 23 on both sides in the chassis longitudinal direction 15. This means that one of the two axles 3, 4 runs through one of the two second battery modules 24, 25.

The battery modules 23, 24, 25 are interconnected by means of a connection interface 26. The connection interface 26 is located in particular in a contact surface between the respective battery modules 23, 24, 25. The connection interface 26 is designed to jointly establish a mechanical connection and an electrical connection and a coolant connection of the battery modules 23, 24, 25. For example, the mechanical connection can be made by screwing and/or welding the battery modules 23, 24, 25 together.

This allows a modular design of the battery arrangement 2 to be provided. Depending on the specifications, a battery arrangement 2 with a different number of battery modules can be provided, for example. For example, the second battery module 25 on the rear axle 4 can be omitted and replaced by another component, for example. Furthermore, additional battery modules can preferably be provided and the battery arrangement 2 can thus be extended. In this way, a particularly flexibly adaptable chassis 1 can be provided in a simple and cost-effective manner.

1. A chassis of a vehicle (10), comprising:
a battery arrangement (2),
a front axle (3), and
a rear axle (4),
wherein the battery arrangement (2) is arranged in an intermediate space (20) between the front and rear axles (3, 4) and additionally partially outside the intermediate space (20) in a chassis longitudinal direction (15), and
wherein the battery arrangement (2) is configured as a co-supporting element of the chassis (1).

2. The chassis according to claim 1, wherein the battery arrangement (2) comprises several battery cells (21) and a battery housing (22), wherein the battery housing (22) forms the co-supporting element.

3. The chassis according to claim 1, wherein the battery arrangement (2) is configured as a one-piece battery module.

4. The chassis according to claim 1, wherein the battery arrangement (2) is formed in several parts and comprises at least two interconnected battery modules (23, 24, 25).

5. The chassis according to claim 4,
wherein the battery arrangement (2) comprises a first battery module (23) and at least one second battery module (24, 25),
wherein the first battery module (23) is arranged in the intermediate space (20), and
wherein the second battery module (24, 25) extends in the chassis longitudinal direction (15) from the first battery module (23) over the respective axle (3, 4).

6. The chassis according to claim 4,
wherein the battery modules (23, 24, 25) are connected to each other by a connection interface (26), and
wherein the connection interface (26) jointly establishes a mechanical connection and an electrical connection and/or a coolant connection.

7. The chassis according to claim 1, further comprising a receiving chamber (5) for accommodating components of the vehicle (10), wherein the receiving chamber (5) is at least partially enclosed by the battery arrangement (2).

8. The chassis according to claim 7, wherein the receiving chamber (5) is completely enclosed by the battery arrangement (2) in at least one plane (50).

9. The chassis according to claim 7, further comprising a cooling system (7) which has a common cooling circuit for the battery arrangement (2) and at least one component accommodated in the receiving chamber (5).

10. The chassis according to claim 7, further comprising an electric motor (6) arranged in the receiving chamber (5).

11. The chassis according to claim 1, further comprising power electronics (8) integrated in the battery arrangement (2).

12. The chassis according to claim 10, wherein electrical lines for an electrical connection of the battery arrangement (2) and the electric motor (6) and/or power electronics (8) are arranged within the battery arrangement (2).

13. The chassis according to claim 1, further comprising a plurality of connecting elements (27) on the battery arrangement (2), which are arranged for connection to a body and/or to chassis components and/or to add-on parts.

14. The chassis according to claim 1, further comprising at least one of a drive train, chassis components, steering components, or wheels.

15. A vehicle comprising a chassis (1) according to claim 1.

16. The chassis according to claim 12, wherein the electrical lines are arranged exclusively within the battery arrangement (2).
